(19) United States
(12) Patent Application Publication
(10) Pub. No.: US 2009/0092019 A1
(43) Pub. Date: Apr. 9, 2009

(54) INFORMATION PROCESSING APPARATUS, DISC, AND INFORMATION PROCESSING METHOD, AND COMPUTER PROGRAM USED THEREWITH

(75) Inventor: Susumu SENSHU, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/233,794

(22) Filed: Sep. 19, 2008

(30) Foreign Application Priority Data
Oct. 5, 2007 (JP) 2007-261781

(51) Int. Cl. G11B 5/58; G06F 21/00

(52) U.S. Cl. 369/53.21; 726/26; G9B/5.202

(57) ABSTRACT

An information processing apparatus includes a data reading unit that reads a media identifier unique to a disc from an integrated-circuit chip included in the disc, a copy permission request unit that transmits data to a management server, the data including the media identifier read by the data reading unit, and a copy execution unit that, on condition of receipt of copy permission information from the management server, reads content recorded on the disc and executes a process of copying and recording the content to a data recording medium different from the disc.

### CROSS REFERENCES TO RELATED APPLICATIONS

The present invention contains subject matter related to Japanese Patent Application JP 2007-261781 filed in the Japanese Patent Office on Oct. 5, 2007, the entire contents of which are incorporated herein by reference.

### BACKGROUND OF THE INVENTION

1. Field of the Invention

The present invention relates to an information processing apparatus, a disc, and an information processing method, and a computer program used therewith. More specifically, the present invention relates to an information processing apparatus, a disc, and an information processing method, and a computer program used therewith that are configured to control access to content stored on information recording media.

2. Description of the Related Art

Discs such as digital versatile discs (DVDs) and Blu-ray Disc® discs are available as recording media for recording content. Entertainment content such as theatrical motion pictures is recorded on discs (e.g., read-only memory (ROM) discs) and is distributed to users. In many cases, such content recorded on discs may be content whose copyright, distribution right, and other rights are owned by its author or seller. Such content has a certain access control structure in order to, for instance, prevent unauthorized copying (duplication) thereof.

The Advanced Access Content System (AACS) is a standard for content copyright protection. AACS specifies a standard for copyright protection technology based on sophisticated common key cryptography techniques (Advanced Encryption Standard (AES) cryptography). In the AACS specification, in order to perform a content access process such as a process of reproducing content from a disc or copying and recording content, identification information recorded on the disc, for example, a Pre-recorded Media Serial Number (PMSN), which is unique identification information for each disc, is read and is subjected to processing in accordance with a sequence specified by AACS, for example, authentication and encryption. In a content-stored disc compatible with the AACS specification, PMSN, which is unique identification information for each disc, is recorded on a burst cutting area (BCA) of the disc.

The BCA area is an area different from a normal data recording area, and data is recorded on the BCA area by using a physical cutting technique, which is different from a standard data recording method. It is therefore difficult to rewrite data recorded on the BCA area, and the reproduction thereof also involves the use of a special reading process, which is different from that of a standard data reproducing process.

A processing sequence of reproducing content recorded on a disc according to the AACS specification, and a processing sequence of copying content recorded on a disc to another medium such as a hard disk will be described with reference to FIGS. 1 and 2.

FIG. 1 is a diagram showing a sequence of reproducing content recorded on a disc according to the AACS specification. FIG. 1 shows, from the left to the right, a disc (information recording medium) 10 storing content, a drive 20 that reads data from the disc 10 placed therein, and a host 30 that obtains data recorded on the disc 10 through the drive 20 to decode and reproduce the content. In FIG. 1, the drive 20 and the host 30 are shown as separate devices. Alternatively, the drive 20 and the host 30 may be integrated into a single apparatus such as a reproducing apparatus. The disc 10 shown at the left end of FIG. 1 is a disc compatible with the AACS standard, and content such as a theatrical motion picture is recorded in advance on the disc 10 as encrypted content 17.

The disc 10 has recorded thereon a content ID 14, which is identification information of the encrypted content 17, a volume ID 15 of the disc 10, which is an identifier assigned to each unit of manufacture, and a Pre-recorded Media Serial Number (PMSN) as a media ID 16, which is unique identification information for each disc. As described above, the media ID (PMSN) 16 is recorded on the BCA area.

The disc 10 has also the following data items recorded thereon:

a script 11, which is a simple program for causing execution of a reproducing or copying process complying with the AACS standard;

a uniform resource locator (URL) 12 of, for example, a server to be connected to obtain permission to copy prior to copying content recorded on a disc; and

a media key block (MKB) 13, which is a cryptographic key block in which key information used for decoding the encrypted content 17 is stored.

The MKB 13 is a cryptographic information (cryptographic key) block generated according to a tree-based key distribution method, which is a broadcast encryption method. The MKB 13 is a cryptographic information block in which an encrypted media key [Km], which is a key necessary for decoding content, is stored, and the media key [Km] can be obtained by performing a process (decoding) using a device key [Kd] stored in a user device having an authorized license.

The drive 20 includes key data 21 including a public key of an AACS management center, a drive public key, and a drive private key, and a host revocation list 22. The host revocation list 22 is a list of recorded pieces of identification information of hosts that are determined to be malicious or unauthorized hosts by the AACS management center, or a blacklist. As host identification information, for example, identification numbers of host public key certificates corresponding to such hosts are recorded. The host revocation list 22 has been signed using a private key of the AACS management center so as not to be tampered with.

The host 30 includes key data 31 including the public key of the AACS management center, a host public key, and a host private key, and a drive revocation list 32. The drive revocation list 32 is a list of recorded pieces of identification information of drives that are determined to be unauthorized drive devices by the AACS management center, or a blacklist. As drive identification information, for example, identification numbers of drive public key certificates corresponding to such drives are recorded. The drive revocation list 32 has also been signed using a private key of the AACS management center so as not to be tampered with. The host revocation list 22 and the drive revocation list 32 may be recorded on the disc 10, and the drive 20 and the host 30 may read and use the data recorded on the disc 10.

A sequence in a case where the host 30 performs reproduction of content will be described. The host 30 and the drive 20 include an authentication processing unit 33 and an authentication processing unit 23, respectively, and, first, an authentication process is executed between the authentication processing unit 33 of the host 30 and the authentication processing unit 23 of the drive 20. The authentication process is executed according to a processing sequence specified by AACS. In this process, the devices mainly execute the following processes.

The drive 20 reads the host revocation list 22, and verifies the signature of the host revocation list 22 using the public key of the AACS management center to ensure that no tampering has occurred. The drive 20 further confirms that the identification information of the host 30 is not described in the host revocation list 22, or that the host 30 is not revoked.

The host 30 also reads the drive revocation list 32, and verifies the signature of the drive revocation list 32 using the public key of the AACS management center to ensure that no tampering has occurred. The host 30 further confirms that the identification information of the drive 20 is not described in the drive revocation list 32, or that the drive 20 is not revoked.

When it is confirmed that either the drive 20 or the host 30 is not revoked, the drive 20 and the host 30 execute communication of encrypted data according to the AACS specification to generate a shared private key to be shared between the drive 20 and the host 30.

After the completion of the host-drive authentication, the drive 20 reads the media ID (PMSN) 16 from the disc 10, and a media access control (MAC) calculation unit 24 executes a MAC generation process using the shared key generated in the authentication process. The drive 20 transmits a generated MAC value and the media ID (PMSN) 16 to the host 30.

As described above, the media ID (PMSN) 16 is recorded on the BCA area, which is different from the normal data recording area, and a special reading process, which is different from that of a normal data reproducing process, is performed.

A MAC calculation unit 34 of the host 30 executes a MAC verification process using the shared key generated in the authentication process. Specifically, the MAC calculation unit 34 performs a MAC generation process using the shared key on the media ID 16 received from the drive 20, and matches a generated MAC value with the MAC value received from the drive 20. When the two MAC values match, it is determined that verification has been successfully established. Then, an encryption processing module 36 executes a process of decoding and reproducing content according to the AACS specification.

In the decoding of content according to the AACS specification, which is executed by the encryption processing module 36, the MKB 13 is processed using a device key [Kd] 35 to obtain a media key [Km] from the MKB 13, and a process using the media key [Km] is performed to obtain a key for decoding the content. Accordingly, a content decoding process is executed.

Next, a processing sequence of copying content recorded on a disc to another medium such as a hard disk will be described with reference to FIG. 2. The copying of content recorded on a disc according to the AACS specification involves the obtaining of copy permission information from a management server according to the AACS specification. Such a copying process based on permission to copy is called Managed Copy.

FIG. 2 shows, from the left to the right, a management server 50 that outputs copy permission information, an information processing apparatus 40 that executes a copying process, and a disc 10 storing content to be copied. The information processing apparatus 40 is an apparatus having both functions of a host and a drive, which have been described with reference to FIG. 1. The disc 10 is a disc compatible with the AACS standard, like the disc 10 described with reference to FIG. 1, and content such as a theatrical motion picture is recorded in advance on the disc 10 as encrypted content 17. Other information recorded on the disc 10 is similar to that described with reference to FIG. 1.

When the information processing apparatus 40 is to copy the encrypted content 17 recorded on the disc 10 to a recording medium 44 such as a hard disk installed in the information processing apparatus 40, the information processing apparatus 40 executes the script 11 (simple program) recorded on the disc 10 using a script execution unit 41 to obtain copy permission information from the management server 50.

The script 11 has recorded therein a program for executing a series of procedures for a copying process. A copy permission request unit 42 of the information processing apparatus 40 reads the content ID 14 and the media ID (PMSN) 16 from the disc 10, and transmits the read ID information to the management server 50 according to the URL 12 recorded on the disc 10. As described above, the media ID (PMSN) 16 is recorded on the BCA area, which is different from the normal data recording area, and is read using a special process, which is different from that of a normal data reproducing process.

A copy permission determination unit 51 of the management server 50 receives the content ID 14 and the media ID (PMSN) 16 from the information processing apparatus 40, and checks the content to be copied and the disc 10 having the content recorded thereon to determine whether or not copying is permitted. The management server 50 stores copy authorization information for every disc and every content item, for example, information indicating that a content item A on a specific disc is a content item that is authorized to be copied one time only.

The copy permission determination unit 51 of the management server 50 determines whether or not a copy request from the information processing apparatus 40 is granted according to the copy authorization information, and sends copy permission/prohibition determination information to the information processing apparatus 40 through a copy permission notification unit 52.

When the information processing apparatus 40 receives copy permission information from the management server 50, a copy execution unit 43 reads the encrypted content 17 recorded on the disc 10 and executes a process of copying the read content 17 to the recording medium 44 such as a hard disk installed in the information processing apparatus 40. In this copying process, the encrypted content 17 can be decoded and recorded as decoded content. In this case, the copy execution unit 43 reads the MKB 13 and the volume ID 15 from the disc 10, and executes a decoding sequence complying with the AACS specification using the read data to obtain the decoded content. The decoded content is recorded on the recording medium 44.

Processing sequences of reproducing content recorded on a disc and copying content recorded on a disc according to the AACS specification have been described with reference to FIGS. 1 and 2. In the sequences described above, both content reproducing and copying processes involve the reading of various data from the disc to perform the individual processes. Specifically, prior to the start of reproduction or copying of content, it is necessary to read a plurality of IDs recorded on a disc and also necessary to perform a disc reproducing process in order to read those IDs. Furthermore, both processes involve the reading of the media ID (PMSN) 16.

As described above, the media ID (PMSN) 16 is recorded on the BCA area, which is different from the normal data recording area, and is read using a special process, which is different from that of a normal data reproducing process. Therefore, an apparatus that is to reproduce or copy content is provided with such a BCA reading function.

In a sequence of the related art for reproducing or copying content, accordingly, it is necessary to play a disc or to read data from the BCA area. In particular, in order to copy content, data is read from the BCA area prior to initiating communication with a management server, and data is read from the normal data recording area after initiating the communication with the management server. Thus, a problem occurs in that the processing load involved before the start of actual copying processes is large and the time involved in the processes is also long.

In the related art, some of data is recorded on, instead of a disc, an element from which data can be read at a high speed, for example, an integrated circuit (IC) chip that enables near field communication based on radio frequency technology. Such a structure is disclosed in, for example, Japanese Unexamined Patent Application Publication No. 2007-133608. Japanese Unexamined Patent Application Publication No. 2007-133608 describes a structure in which software identification information or access control information necessary for installing software recorded on an optical disc having an IC chip embedded therein is recorded on the IC chip and pre-processing prior to installing the software is executed using the information recorded on the IC chip. Japanese Unexamined Patent Application Publication No. 2005-316994 discloses a structure in which a radio frequency identification (RFID) tag is embedded in an optical disc and key information is recorded on the RFID tag. However, neither Japanese Unexamined Patent Application Publication No. 2007-133608 nor 2005-316994 mentioned above discloses the recording or reading of data necessary for a process of copying content recorded on a disc or other appropriate processes on or from an IC chip.

### SUMMARY OF THE INVENTION

It is desirable to provide an information processing apparatus, a disc, and an information processing method, and a computer program used therewith in which in a process of copying content recorded on a disc, information necessary to obtain authorization information from a management server can be obtained quickly to enable rapid obtaining of permission to copy.

According to an embodiment of the present invention, an information processing apparatus includes data reading means for reading a media identifier unique to a disc from an integrated-circuit chip included in the disc; copy permission request means for transmitting data to a management server, the data including the media identifier read by the data reading means; and copy execution means for, on condition of receipt of copy permission information from the management server, reading content recorded on the disc and executing a process of copying and recording the content to data recording means different from the disc.

The integrated-circuit chip may be configured to have recorded thereon:

(a) the media identifier configured to uniquely identify the disc; and

(b) a content identifier configured to identify the content recorded on the disc.

The data reading means may be configured to read the media identifier and the content identifier from the integrated-circuit chip, and the copy permission request means may be configured to execute a process of transmitting the media identifier and content identifier read from the integrated-circuit chip to the management server.

The information processing apparatus may further include script execution means for executing a script recorded on the disc, the script being a simple program. The copy permission request means and the copy execution means may perform individual processes according to a program included in the script executed by the script execution means.

Alternatively, the integrated-circuit chip may be configured to have recorded thereon:

(a) the media identifier configured to uniquely identify the disc;

(b) the script that is a simple program; and

(c) a Uniform Resource Locator specifying an address of the management server.

The data reading means may be configured to read the script from the integrated-circuit chip. The script execution means may be configured to execute the script read from the integrated-circuit chip. The copy permission request means may be configured to execute a process of transmitting data to the management server specified by the Uniform Resource Locator, the data including the media identifier read from the integrated-circuit chip.

The information processing apparatus may further include an authentication processing unit that executes an authentication process. The authentication processing unit may be configured to perform an authentication process with an authentication processing unit provided in the integrated-circuit chip included in the disc. The information processing apparatus may be configured to execute a process of accessing data recorded on the integrated-circuit chip on condition of establishment of the authentication process.

Furthermore, the media identifier may be a Pre-recorded Media Serial Number specified by the Advanced Access Content System.

According to another embodiment of the present invention, a disc having content recorded thereon includes a data recording portion on which content is recorded; and an integrated-circuit chip on which a media identifier unique to the disc is recorded. The integrated-circuit chip is configured so that the media identifier can be read using contactless data reading means, and an information processing apparatus is to access the content recorded on the disc, the information processing apparatus is allowed to read the media identifier from the integrated-circuit chip and to execute a data process using the media identifier.

The integrated-circuit chip may be configured to have recorded thereon:

(a) the media identifier configured to uniquely identify the disc; and

(b) a content identifier configured to identify the content recorded on the disc.

When the information processing apparatus is to access the content recorded on the disc, the information processing apparatus may be allowed to read the media identifier and the content identifier from the integrated-circuit chip and to execute the process using the read media identifier and content identifier.

Alternatively, the integrated-circuit chip may be configured to have recorded thereon:

(a) the media identifier configured to uniquely identify the disc;

(b) a script that is a simple program; and

(c) a Uniform Resource Locator specifying an address of a management server.

When the information processing apparatus is to access the content recorded on the disc, the information processing apparatus may be allowed to read data from the integrated-circuit chip and to execute the script to perform a process of transmitting the media identifier to the management server specified by the Uniform Resource Locator.

The integrated-circuit chip may include an authentication processing unit that executes an authentication process, and the authentication processing unit may be configured to perform an authentication process with the information processing apparatus that is to access the content recorded on the disc.

Furthermore, the media identifier may be a Pre-recorded Media Serial Number specified by the Advanced Access Content System.

According to still another embodiment of the present invention, an information processing method for performing a process of accessing content recorded on a disc using an information processing apparatus includes the steps of reading, using data reading means, a media identifier unique to a disc from an integrated-circuit chip included in the disc; transmitting, using copy permission request means, data to a management server, the data including the media identifier read by the data reading means; and executing a copying operation, using copy execution means, on condition of receipt of copy permission information from the management server, by reading content recorded on the disc and executing a process of copying and recording the content to data recording means different from the disc.

The integrated-circuit chip may be configured to have recorded thereon:

(a) the media identifier configured to uniquely identify the disc; and

(b) a content identifier configured to identify the content recorded on the disc.

The step of transmitting data may include executing a process of transmitting the media identifier and content identifier read from the integrated-circuit chip through the data reading means to the management server.

The information processing method may further include the step of executing, using script execution means, a script recorded on the disc, the script being a simple program. The step of transmitting data and the step of executing a copying operation may perform individual processes according to a program included in the script executed in the step of executing a script.

Alternatively, the integrated-circuit chip may be configured to have recorded thereon:

(a) the media identifier configured to uniquely identify the disc;

(b) the script that is a simple program; and

(c) a Uniform Resource Locator specifying an address of the management server.

The step of executing a script may include executing the script read from the integrated-circuit chip through the data reading means, and the step of transmitting data may include executing a process of transmitting data to the management server specified by the Uniform Resource Locator, the data including the media identifier read from the integrated-circuit chip through the data reading means.

The information processing method may further include the step of performing, using an authentication processing unit, an authentication process with an authentication processing unit provided in the integrated-circuit chip included in the disc. The information processing apparatus may execute a process of accessing data recorded on the integrated-circuit chip on condition of establishment of the authentication process.

Furthermore, the media identifier may be a Pre-recorded Media Serial Number specified by the Advanced Access Content System.

According to still another embodiment of the present invention, a computer program for causing an information processing apparatus to perform a process of accessing content recorded on a disc includes the steps of causing data reading means to read a media identifier unique to a disc from an integrated-circuit chip included in the disc; causing copy permission request means to transmit data to a management server, the data including the media identifier read by the data reading means; and causing copy execution means to read, on condition of receipt of copy permission information from the management server, content recorded on the disc and execute a process of copying and recording the content to data recording means different from the disc.

A computer program according to an embodiment of the present invention may be, for example, a computer program that can be provided to a general-purpose computer system capable of executing various program code through a storage medium or communication medium configured to provide the program in a computer-readable form. By providing the program in a computer-readable form, a process in accordance with the program is implemented on a computer system.

Further features, advantages, and embodiments of the present invention will become apparent from the following detailed description of embodiments of the present invention, taken in conjunction with the accompanying drawings. The term “system” as used herein refers to a logical set of apparatuses regardless of whether or not the apparatuses are housed in a single housing.

According to an embodiment of the present invention, a disc having content recorded thereon includes an IC chip on which a media ID (PMSN), which is unique identification information for each disc, is recorded. The media ID read from the IC chip is transmitted to a server to obtain copy permission information of the content stored on the disc. With this structure, for instance, the reading of PMSN data from a BCA area of the disc having the content recorded thereon, on which the media ID (PMSN) is recorded according to the AACS specification, can be omitted. This facilitates rapid reading of data from the IC chip to obtain the media ID, and allows an efficient process of obtaining copy permission information.

### BRIEF DESCRIPTION OF THE DRAWINGS

FIG. 1 is a diagram showing a sequence of reproducing content recorded on a disc according to the AACS specification;

FIG. 2 is a diagram showing a sequence of copying content recorded on a disc according to the AACS specification;

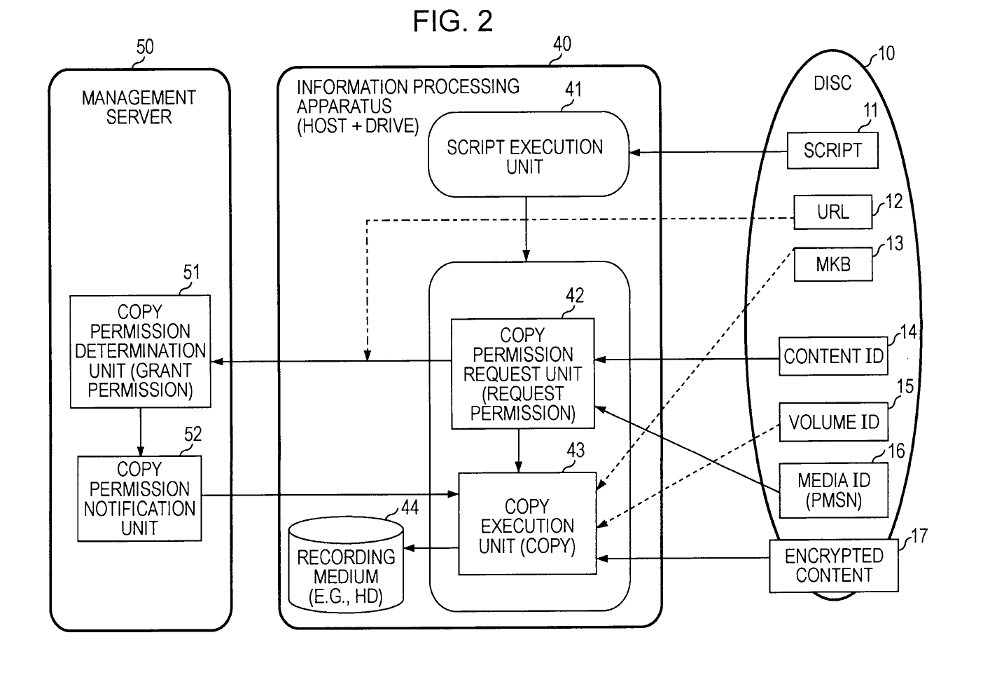

FIG. 3 is a diagram showing an example structure of data recorded on a disc according to a first embodiment of the present invention;

FIG. 4 is a diagram showing a sequence of copying content recorded on the disc according to the first embodiment of the present invention;

FIG. 5 is a diagram showing an example structure of data recorded on a disc according to a second embodiment of the present invention;

FIG. 6 is a diagram showing a sequence of copying content recorded on the disc according to the second embodiment of the present invention;

FIG. 7 is a diagram showing an example structure of data recorded on a disc according to a third embodiment of the present invention;

FIG. 8 is a diagram showing a sequence of copying content recorded on the disc according to the third embodiment of the present invention;

FIG. 9 is a diagram showing an example structure of data recorded on a disc according to a fourth embodiment of the present invention;

FIG. 10 is a diagram showing an authentication sequence according to the fourth embodiment of the present invention;

FIG. 11 is a diagram showing an example structure of data recorded on a disc according to a fifth embodiment of the present invention;

FIG. 12 is a diagram showing a sequence of reproducing content recorded on the disc according to the fifth embodiment of the present invention; and

FIG. 13 is a diagram showing a sequence of copying content recorded on the disc according to the fifth embodiment of the present invention.

### DESCRIPTION OF THE PREFERRED EMBODIMENTS

An information processing apparatus, a disc, and an information processing method, and a computer program used therewith according to embodiments of the present invention will be described in detail hereinafter with reference to the drawings.

Embodiments of the present invention will be described in sequence.

### First Embodiment

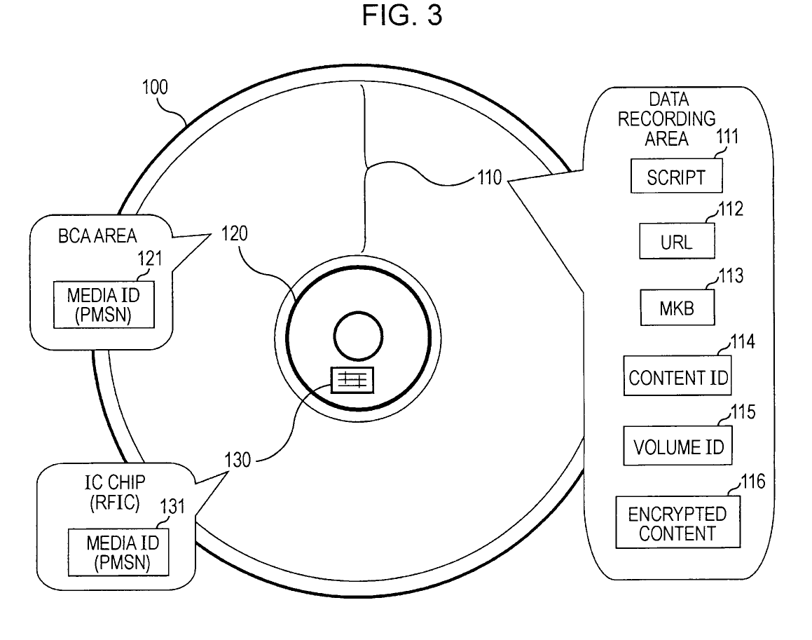

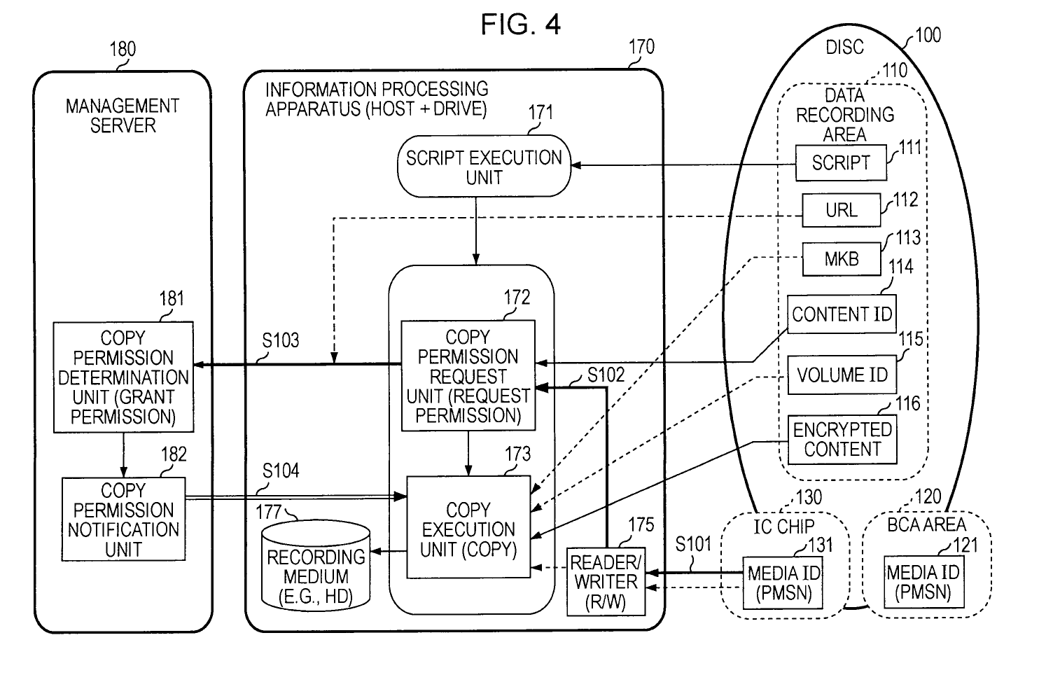

First, the structure and process of a first embodiment of the present invention will be described with reference to FIGS. 3 and 4. FIG. 3 is a diagram showing data recorded on a disc (information recording medium) 100 having content recorded thereon. The disc 100 is a disc, such as a DVD or a Blu-ray Disc® disc, having content such as a theatrical motion picture recorded on a data recording area thereof.

The disc 100 includes a data recording area 110 on which content etc., are recorded, and a BCA area 120 on which a media ID (for example, PMSN) 121, which is unique identification information for each disc, is recorded. The disc 100 further includes an IC chip 130 on which a media ID (PMSN) 131, which is the same as the media ID 121 recorded on the BCA area 120, is recorded.

The disc 100 is a disc manufactured according to the AACS standard, which is a standard for content copyright protection, and data for accessing content according to the AACS standard is recorded on the data recording area 110 and the BCA area 120.

The data recording area 110 of the disc 100 has the following data items recorded thereon:

a script 111, which is a simple program for causing execution of a reproducing or copying process complying with the AACS specification;

a URL 112 of, for example, a server to be connected to obtain permission to copy prior to copying content recorded on a disc;

an MKB 113, which is a cryptographic key block in which key information used for decoding encrypted content 116 is stored;

a content ID 114, which is identification information of the encrypted content 116;

a volume ID 115 of the disc 100, which is an identifier assigned to each unit of manufacture; and

the encrypted content 116, which is data obtained by encrypting content such as a theatrical motion picture.

The data items described above is recorded on the data recording area 110.

The BCA area 120 of the disc 100 has the media ID (PMSN) 121 recorded thereon, which is unique identification information for each disc.

As described above, a BCA area is an area different from a normal data recording area, and data is recorded on the BCA area by using a physical cutting technique, which is different from a standard data recording method. It is therefore difficult to rewrite data recorded on the BCA area, and the reproduction thereof also involves the use of a special reading process, which is different from that of a standard data reproducing process.

The IC chip 130 provided in the disc 100 has the media ID (PMSN) 131 recorded thereon, which is unique identification information for each disc.

The media ID (PMSN) 131 recorded on the IC chip 130 and the media ID (PMSN) 121 recorded on the BCA area 120 are identical to each other.

The IC chip 130 is, for example, an IC chip called a radio frequency IC (RFIC) having a communication function for performing communication with a reader/writer (or a reader) placed in contact or contactless with the IC chip 130. The IC chip 130 has a function for outputting the media ID (PMSN) 131 stored on a memory in the IC chip 130 to the reader/writer. The IC chip 130 executes a process of receiving, using an antenna, a radio wave or magnetic field output from the reader/writer, converting the received radio wave or magnetic field into electric power, and outputting the media ID (PMSN) 131 stored on the memory to the reader/writer.

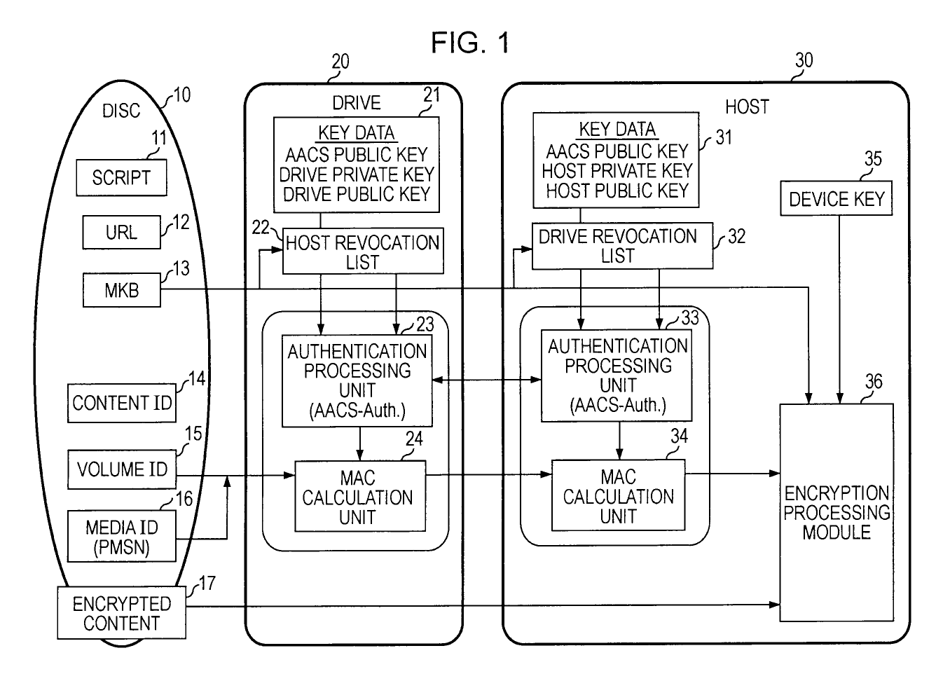

A process of reproducing content recorded on a disc having the data storage structure shown in FIG. 3 can be executed as a process similar to that complying with the AACS specification described above with reference to FIG. 1.

Next, a processing sequence of copying content stored on a disc having the data storage structure shown in FIG. 3 will be described with reference to FIG. 4. Specifically, a processing sequence of copying content recorded on a disc to another medium such as a hard disk will be described. As described previously, the copying of content recorded on a disc according to the AACS specification involves the obtaining of copy permission information from a management server according to the AACS specification. Such a copying process based on permission to copy is called Managed Copy.

FIG. 4 shows, from the left to the right, a management server 180 that outputs copy permission information, an information processing apparatus 170 that executes a copying process, and a disc 100 storing content to be copied. The disc 100 is a disc having the data recording structure described with reference to FIG. 3, and has a structure in which an identical media ID (PMSN) is recorded on the BCA area 120 and the IC chip 130.

The information processing apparatus 170 is an apparatus having both functions of a host for executing a content reproducing process or copying process and of a drive for driving a disc and reading data.

When the information processing apparatus 170 is to copy the encrypted content 116 recorded on the disc 100 to a recording medium 177 such as a hard disk installed in the information processing apparatus 170, first, the information processing apparatus 170 executes the script 111 (simple program) recorded on the disc 100 using a script execution unit 171 to obtain copy permission information from the management server 180.

The script 111 has recorded therein a program for executing a series of procedures for a copying process. A copy permission request unit 172 of the information processing apparatus 170 reads the content ID 114 from the data recording area 110 of the disc 100, and the media ID (PMSN) 131 recorded on the IC chip 130 through a reader/writer (R/W) 175, and transmits the read ID information to the management server 180 according to the URL 112 recorded on the data recording area 110 of the disc 100 .

A sequence of transferring the media ID (PMSN) 131 read from the IC chip 130 is performed by steps S101 to S103, which are indicated by thick lines shown in FIG. 4. In this exemplary process, since the media ID (PMSN) 131 is read from the IC chip 130, the reading of the media ID (PMSN) 121 from the BCA area 120 can be omitted. The reading of data from the BCA area 120 generally involves the use of a special reading process, which is different from that for the normal data recording area 110. In this exemplary process, the reading of data from the BCA area 120 can be omitted.

The copy permission request unit 172 of the information processing apparatus 170 transmits the content ID 114 and the media ID (PMSN) 131 read from the IC chip 130 in the manner described above to the management server 180 according to the URL 112 recorded on the data recording area 110 of the disc 100.

A copy permission determination unit 181 of the management server 180 receives the content ID 114 and the media ID (PMSN) 131 from the information processing apparatus 170, and checks the content to be copied and the disc 100 having the content recorded thereon to determine whether or not copying is permitted. The management server 180 stores, for example, copy authorization information for every disc and every content as management information. Based on this management information, the copy permission determination unit 181 determines whether or not copying is permitted, and sends copy permission/prohibition determination information to the information processing apparatus 170 through a copy permission notification unit 182 (step S104 of FIG. 4).

When the information processing apparatus 170 receives copy permission information from the management server 180, a copy execution unit 173 reads the encrypted content 116 recorded on the data recording area 110 of the disc 100 and executes a process of copying the read content 116 to the recording medium 177 such as a hard disk installed in the information processing apparatus 170. In this copying process, the encrypted content 116 may be decoded and recorded as decoded content. In this case, the copy execution unit 173 reads information necessary for the decoding process, such as the MKB 113 and volume ID 115 recorded on the data recording area 110 and the media ID (PMSN) 131 recorded on the IC chip 130, and executes a decoding sequence complying with the AACS specification using the read data to obtain the decoded content. The decoded content is recorded on the recording medium 177. The media ID (PMSN) 131 may be implemented using information read during the process of obtaining copy permission information and recoded on a memory in the information processing apparatus 170.

In the content copying process according to the first embodiment, therefore, the process can be performed without reading the media ID (PMSN) 121 recorded on the BCA area 120. This allows rapid obtaining of copy permission information from the management server 180.

While the disc 100 is configured such that a redundant media ID (PMSN) is recorded on the IC chip 130, other data recording structure of the disc 100 complies with the AACS standard. Thus, a content reproducing process complying with the AACS standard can be executed.

### Second Embodiment

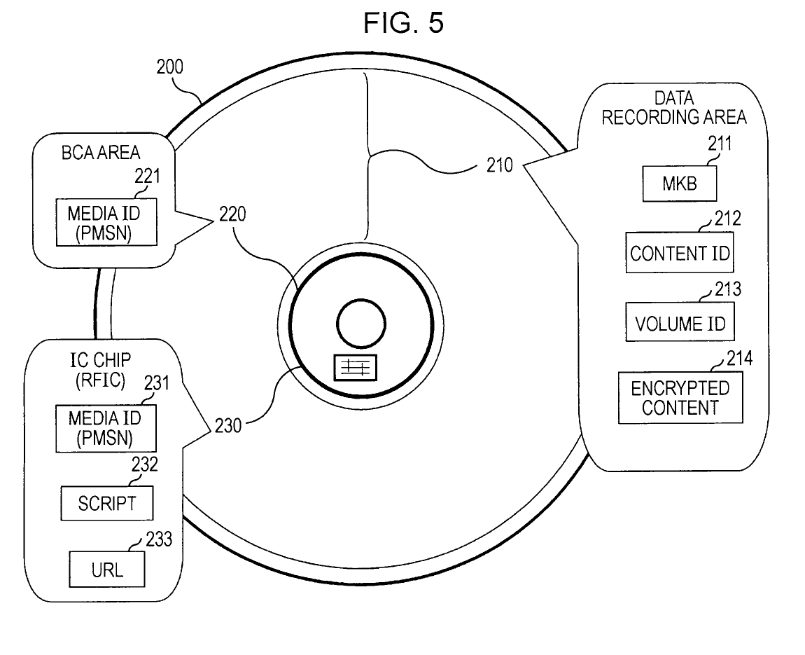

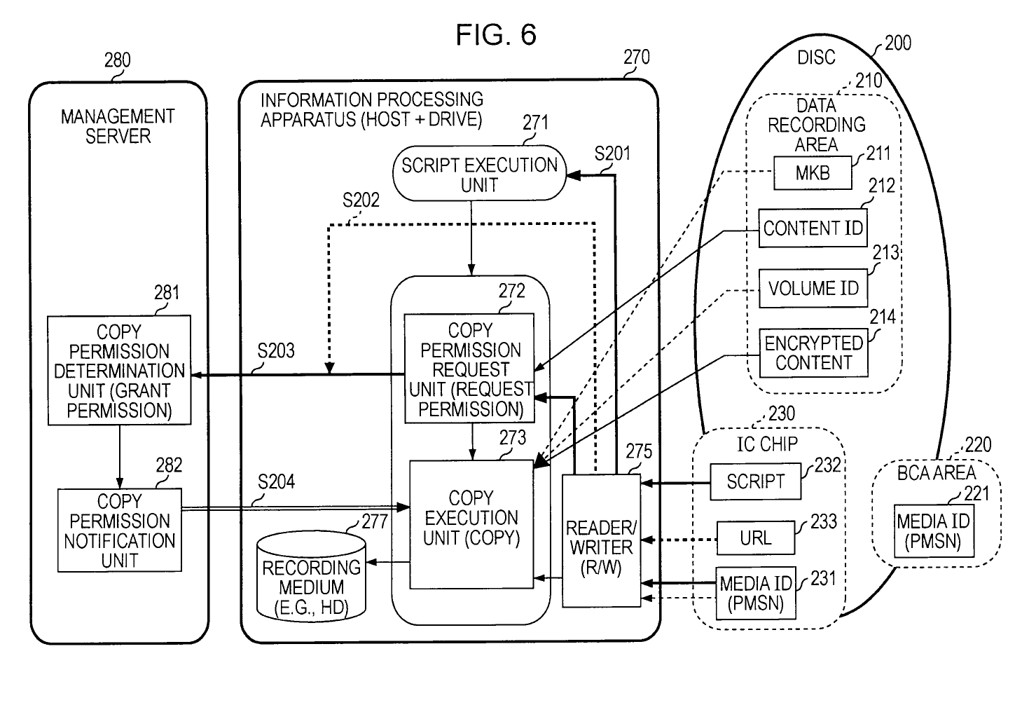

Next, the structure and process of a second embodiment of the present invention will be described with reference to FIGS. 5 and 6. FIG. 5 is a diagram showing data recorded on a disc (information recording medium) 200 having content recorded thereon. The disc 200 is a disc, such as a DVD or a Blu-ray Disc® disc, having content such as a theatrical motion picture recorded on a data recording area thereof.

The disc 200 includes, similarly to the disc 100 of the first embodiment described with reference to FIG. 3, a data recording area 210 on which content etc., are recorded, and a BCA area 220 on which a media ID (for example, PMSN) 221, which is unique identification information for each disc, is recorded. The disc 200 further includes an IC chip 230 on which a media ID (PMSN) 231, which is the same as the media ID 221 recorded on the BCA area 220, is recorded.

In the second embodiment, the IC chip 230 further has the following data items recorded thereon:

(a) a script 232, which is a simple program for causing execution of a reproducing or copying process complying with the AACS specification; and

(b) a URL 233 of, for example, a server to be connected to obtain permission to copy prior to copying content recorded on a disc.

In the first embodiment, the data items (a) and (b) are recorded on the data recording area. In the second embodiment, however, the data items (a) and (b) are recorded on the IC chip 230 instead of the data recording area 210.

The data recording area 210 of the disc 200 has the following data items recorded thereon:

an MKB 211, which is a cryptographic key block in which key information used for decoding encrypted content 214 is stored;

a content ID 212, which is identification information of the encrypted content 214;

a volume ID 213 of the disc 200, which is an identifier assigned to each unit of manufacture; and

the encrypted content 214, which is data obtained by encrypting content such as a theatrical motion picture.

The data items described above are recorded on the data recording area 210.

The BCA area 220 of the disc 200 has a media ID (PMSN) 221 recorded thereon, which is unique identification information for each disc.

As described above, a BCA area is an area different from a normal data recording area, and data is recorded on the BCA area by using a physical cutting technique, which is different from a standard data recording method. It is therefore difficult to rewrite data recorded on the BCA area, and the reproduction thereof also involves the use of a special reading process, which is different from that of a standard data reproducing process.

As described above, the IC chip 230 provided in the disc 200 has the following data items recorded thereon:

the media ID (PMSN) 231, which is unique identification information for each disc;

the script 232, which is a simple program for causing execution of a reproducing or copying process complying with the AACS specification; and

the URL 233 of, for example, a server to be connected to obtain permission to copy prior to copying content recorded on a disc.

The media ID (PMSN) 231 recorded on the IC chip 230 and the media ID (PMSN) 221 recorded on the BCA area 220 are identical to each other.

A process of reproducing content recorded on a disc having the data storage structure shown in FIG. 5 can be executed as a process similar to that complying with the AACS specification described above with reference to FIG. 1.

Next, a processing sequence of copying content stored on a disc having the data storage structure shown in FIG. 5 will be described with reference to FIG. 6. Specifically, a processing sequence of copying content recorded on a disc to another medium such as a hard disk will be described.

FIG. 6 shows, from the left to the right, a management server 280 that outputs copy permission information, an information processing apparatus 270 that executes a copying process, and a disc 200 storing content to be copied. The disc 200 is a disc having the data recording structure described with reference to FIG. 5, and has a structure in which an identical media ID (PMSN) is recorded on the BCA area 220 and the IC chip 230.

The information processing apparatus 270 is an apparatus having both functions of a host for executing a content reproducing process or copying process and of a drive for driving a disc and reading data.

When the information processing apparatus 270 is to copy the encrypted content 214 recorded on the disc 200 to a recording medium 277 such as a hard disk installed in the information processing apparatus 270, first, the information processing apparatus 270 executes the script (simple program) 232 recorded on the disc 200 using a script execution unit 271 to obtain copy permission information from the management server 280.

In the second embodiment, the script 232 is recorded on the IC chip 230. The information processing apparatus 270 obtains the script 232 from the IC chip 230 through a reader/writer (R/W) 275, and executes the script 232 using the script execution unit 271. In FIG. 6, the processing of step S201 corresponds to a process of reading the script 232.

The script 232 has recorded therein a program for executing a series of procedures for a copying process. A copy permission request unit 272 of the information processing apparatus 270 reads the content ID 212 from the data recording area 210 of the disc 200, and further reads the media ID (PMSN) 231 recorded on the IC chip 230 through the reader/writer (R/W) 275. The copy permission request unit 272 further reads the URL 233 recorded on the IC chip 230 through the reader/writer (R/W) 275. In FIG. 6, the processing of step S202 corresponds to a process of reading and accessing the URL 233.

The information processing apparatus 270 transmits the content ID 212 and the media ID (PMSN) 231 to the management server 280 according to the URL 233. In FIG. 6, the processing of step S203 corresponds to a process of transmitting the content ID 212 and the media ID (PMSN) 231.

Also in this exemplary process, since the media ID (PMSN) 231 is read from the IC chip 230, the reading of the media ID (PMSN) 221 from the BCA area 220 can be omitted. The reading of data from the BCA area generally involves the use of a special reading process, which is different from that of the normal data recording area 210. In this exemplary process, the reading of data from the BCA area 220 can be omitted.

The copy permission request unit 272 of the information processing apparatus 270 transmits the content ID 212 and the media ID (PMSN) 231 read from the IC chip 230 in the manner described above to the management server 280 according to the URL 233 read from the IC chip 230.

A copy permission determination unit 281 of the management server 280 receives the content ID 212 and the media ID (PMSN) 231 from the information processing apparatus 270, and checks the content to be copied and the disc 200 having the content recorded thereon to determine whether or not copying is permitted. The copy permission determination unit 281 sends copy permission/prohibition determination information to the information processing apparatus 270 through a copy permission notification unit 282 (step S204 of FIG. 6).

When the information processing apparatus 270 receives copy permission information from the management server 280, a copy execution unit 273 reads the encrypted content 214 recorded on the data recording area 210 of the disc 200, and executes a process of copying the read content 214 to the recording medium 277 such as a hard disk installed in the information processing apparatus 270. In this copying process, the encrypted content 216 may be decoded and recorded as decoded content. In this case, the copy execution unit 273 reads information necessary for the decoding process, such as the MKB 211 and volume ID 213 recorded on the data recording area 210 and the media ID (PMSN) 231 recorded on the IC chip 230, and executes a decoding sequence complying with the AACS specification using the read data to obtain the decoded content. The decoded content is recorded on the recording medium 277. The media ID (PMSN) 231 may be implemented using information read during the process of obtaining copy permission information and recorded on a memory in the information processing apparatus 270.

In the content copying process according to the second embodiment, therefore, similarly to that according to the first embodiment, the process can be performed without reading the media ID (PMSN) 221 recorded on the BCA area 220. This allows rapid obtaining of copy permission information from the management server 280.

In the second embodiment, the IC chip 230 has the following data items recorded thereon:

(a) the script 232, which is a simple program for causing execution of a reproducing or copying process complying with the AACS specification; and

(b) the URL 233 of, for example, a server to be connected to obtain permission to copy prior to copying content recorded on a disc.

Since the IC chip 230 is configured to enable the recording or erasing of data, there is an advantage in that the updating of a script defining a server connection processing method or the like or a URL defining a connection destination server can be performed by rewriting data to modify the data.

In existing AACS-compatible discs, scripts and URLs are recorded on a data recording area. There arises a problem in that it is difficult to change data once recorded on a disc if the disc is a non-recordable disc such as a ROM disc. As in the present embodiment, with a structure in which a script and a URL are written to an IC chip, data can be updated at any time such as when the script is modified or when a URL of a connection destination server is modified.

### Third Embodiment

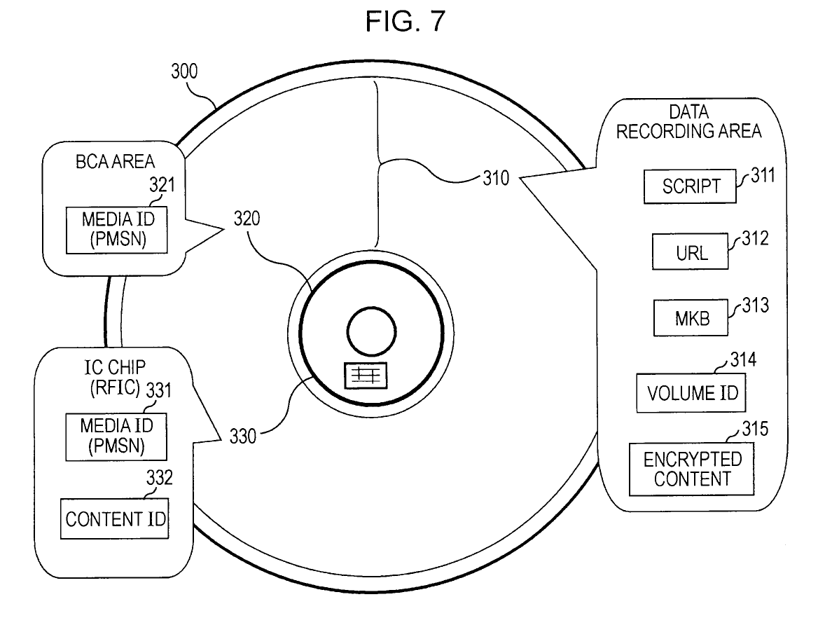

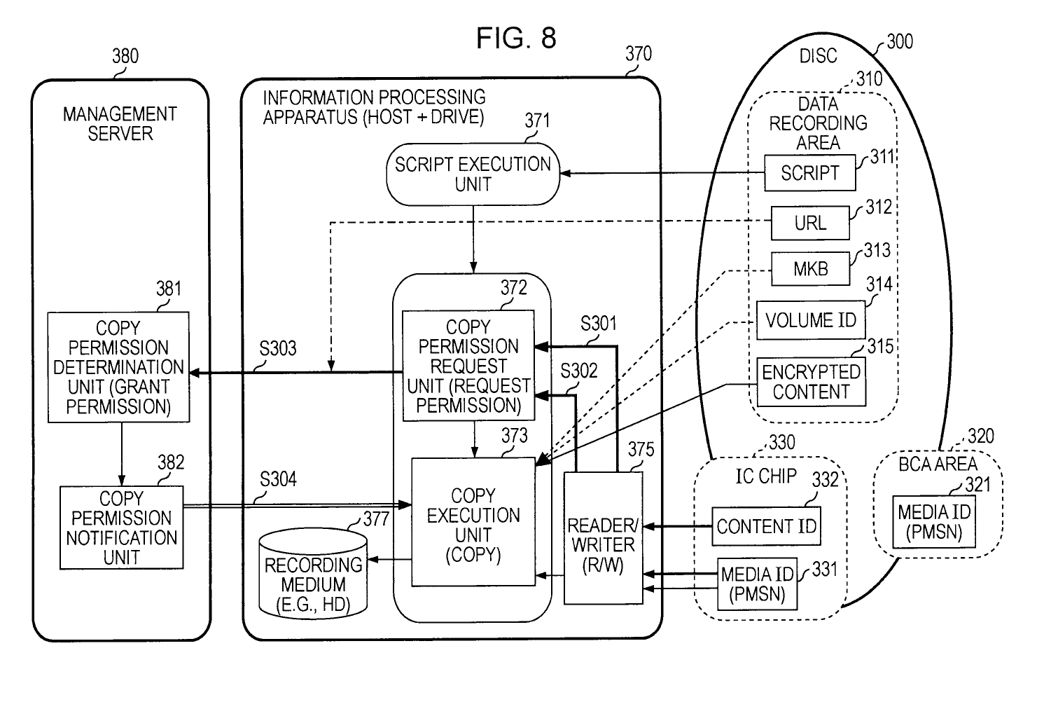

Next, the structure and process of a third embodiment of the present invention will be described with reference to FIGS. 7 and 8. FIG. 7 is a diagram showing data recorded on a disc (information recording medium) 300 having content recorded thereon. The disc 300 is a disc, such as a DVD or a Blu-ray Disc® disc, having content such as a theatrical motion picture recorded on a data recording area thereof.

The disc 300 includes, similarly to the disc 100 of the first embodiment described above with reference to FIG. 3, a data recording area 310 on which content etc., are recorded, and a BCA area 320 on which a media ID (for example, PMSN) 321, which is unique identification information for each disc, is recorded. The disc 300 further includes an IC chip 330 on which a media ID (PMSN) 331, which is the same as the media ID 321 recorded on the BCA area 320, is recorded.

In the third embodiment, the IC chip 330 further has a content ID 332 recorded thereon, which is identification information of encrypted content 315.

In the first embodiment, the content ID is recorded on the data recording area. In the third embodiment, however, this data item is recorded on the IC chip 330 instead of the data recording area 310.

The data recording area 310 of the disc 300 has the following data items recorded thereon:

a script 311, which is a simple program for causing execution of a reproducing or copying process complying with the AACS specification;

a URL 312 of, for example, a server to be connected to obtain permission to copy prior to copying content stored on a disc;

an MKB 313, which is a cryptographic key block in which key information used for decoding encrypted content 315 is stored;

a volume ID 314 of the disc 300, which is an identifier assigned to each unit of manufacture; and

the encrypted content 315, which is data obtained by encrypting content such as a theatrical motion picture.

The data items described above are recorded on the data recording area 310.

The BCA area 320 of the disc 300 has the media ID (PMSN) 321 recorded thereon, which is unique identification information for each disc.

As described above, a BCA area is an area different from a normal data recording area, and data is recorded on the BCA area by using a physical cutting technique, which is different from a standard data recording method. It is therefore difficult to rewrite data recorded on the BCA area, and the reproduction thereof also involves the use of a special reading process, which is different from that of a standard data reproducing process.

As described above, the IC chip 330 provided in the disc 300 has the following data items recorded thereon:

the media ID (PMSN) 331, which is unique identification information for each disc; and

the content ID 332, which is identification information of the encrypted content 315.

The media ID (PMSN) 331 recorded on the IC chip 330 and the media ID (PMSN) 321 recorded on the BCA area 320 are identical to each other.

A process of reproducing content stored on a disc having the data storage structure shown in FIG. 7 can be executed as a process similar to that complying with the AACS specification described above with reference to FIG. 1.

Next, a processing sequence of copying content stored on a disc having the data storage structure shown in FIG. 7 will be described with reference to FIG. 8. Specifically, a processing sequence of copying content recorded on a disc to another medium such as a hard disk will be described.

FIG. 8 shows, from the left to the right, a management server 380 that outputs copy permission information, an information processing apparatus 370 that executes a copying process, and a disc 300 storing content to be copied. The disc 300 is a disc having the data recording structure described with reference to FIG. 7, and has a structure in which an identical media ID (PMSN) is recorded on the BCA area 320 and the IC chip 330.

The information processing apparatus 370 is an apparatus having both functions of a host for executing a content reproducing process or copying process and of a drive for driving a disc and reading data.

When the information processing apparatus 370 is to copy the encrypted content 315 recorded on the disc 300 to a recording medium 377 such as a hard disk installed in the information processing apparatus 370, first, the information processing apparatus 370 executes the script (simple program) 311 recorded on the disc 300 using a script execution unit 371 to obtain copy permission information from the management server 380.

The script 311 has recorded therein a program for executing a series of procedures for a copying process. A copy permission request unit 372 of the information processing apparatus 370 reads the media ID (PMSN) 331 and content ID 332 recorded on the IC chip 330 through a reader/writer (R/W) 375. In FIG. 8, the processing of steps S301 and S302 corresponds to a process of reading the media ID (PMSN) 331 and content ID 332 recorded on the IC chip 330 through the reader/writer (R/W) 375.

The copy permission request unit 372 of the information processing apparatus 370 transmits the content ID 332 and the media ID (PMSN) 331 to the management server 380 according to the URL 312 recorded on the data recording area 310. In FIG. 8, the processing of step S303 corresponds to a process of transmitting the content ID 332 and the media ID (PMSN) 331.

In this exemplary process, the media ID (PMSN) and the content ID are read from the IC chip 330. The reading of the media ID (PMSN) 321 from the BCA area 320 is omitted, and the time involved in reading data from the data recording area 310 can be reduced.

The copy permission request unit 372 of the information processing apparatus 370 transmits the content ID 332 and the media ID (PMSN) 331 read from the IC chip 330 in the manner described above to the management server 380 according to the URL 312.

A copy permission determination unit 381 of the management server 280 receives the content ID 332 and the media ID (PMSN) 331 from the information processing apparatus 370, and checks the content to be copied and the disc 300 having the content recorded thereon to determine whether or not copying is permitted. The copy permission determination unit 381 sends copy permission/prohibition determination information to the information processing apparatus 370 through a copy permission notification unit 382 (step S304 of FIG. 6).

When the information processing apparatus 370 receives copy permission information from the management server 380, a copy execution unit 373 reads the encrypted content 315 recorded on the data recording area 310 of the disc 300, and executes a process of copying the read content 315 to the recording medium 377 such as a hard disk installed in the information processing apparatus 370. In this copying process, the encrypted content 315 may be decoded and recorded as decoded content. In this case, the copy execution unit 373 reads information necessary for the decoding process, such as the MKB 313 and volume ID 314 recorded on the data recording area 310 and the media ID (PMSN) 331 recorded on the IC chip 330, and executes a decoding sequence complying with the AACS specification using the read data to obtain the decoded content. The decoded content is recorded on the recording medium 377. The media ID (PMSN) 331 may be implemented using information read during the process of obtaining copy permission information and recorded on a memory in the information processing apparatus 370.

Also in the content copying process according to the third embodiment, therefore, similarly to the processes according to the first and second embodiments, the process can be performed without reading the media ID (PMSN) 321 recorded on the BCA area 320. This allows rapid obtaining of copy permission information from the management server 380.

In the third embodiment, the IC chip 330 has the content ID 332 recorded thereon, which is identification information of the encrypted content 315. Thus, the reading of the media ID (PMSN) 321 from the BCA area 220 can be omitted, and the time involved in reading data from the data recording area 310 can be reduced.

In the second embodiment, a structure in which, in addition to a media ID, a script and a URL are recorded on an IC chip has been described. In the third embodiment, a structure in which, in addition to a media ID, a content ID is recorded on an IC chip has been described. The structures of the second and third embodiments may be combined. That is, in addition to a media ID, a script, a URL, and a content ID may be recorded on an IC chip. With this structure, the reading of data from the data recording area of a disc can be omitted during the process of obtaining copy permission information.

### Fourth Embodiment

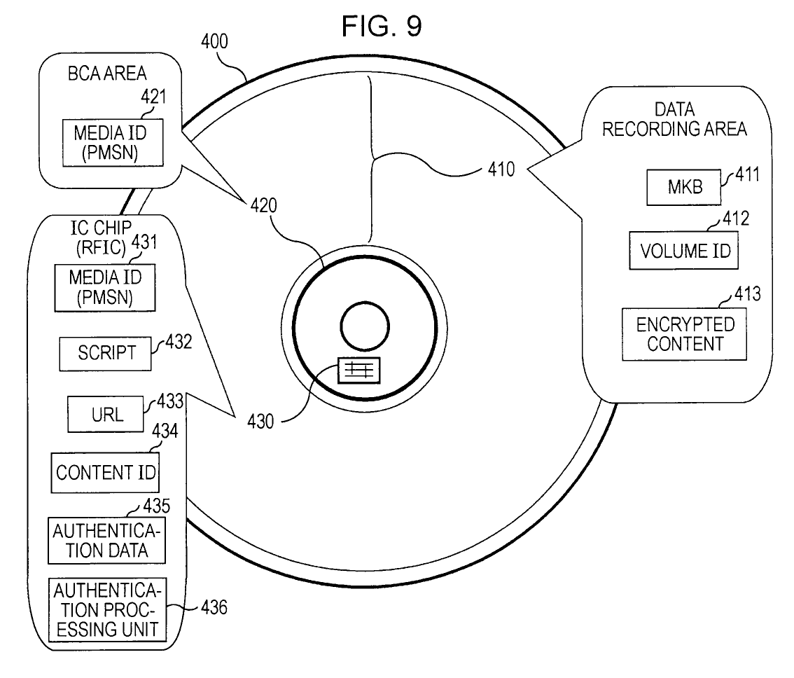

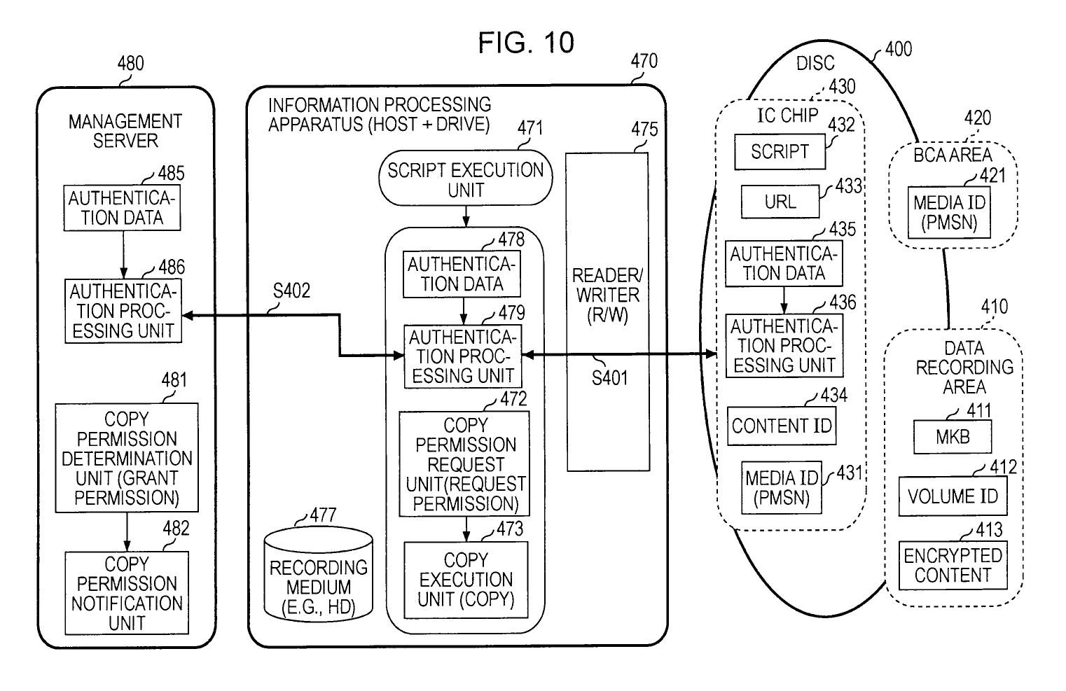

Next, the structure and process of a fourth embodiment of the present invention will be described with reference to FIGS. 9 and 10. FIG. 9 is a diagram showing data recorded on a disc (information recording medium) 400 having content recorded thereon. The disc 400 is a disc, such as a DVD or a Blu-ray Disc® disc, having content such as a theatrical motion picture recorded on a data recording area thereof.

The disc 400 includes, similarly to the disc 100 of the first embodiment described above with reference to FIG. 3, a data recording area 410 on which content etc., are recorded, and a BCA area 420 on which a media ID (for example, PMSN) 421, which is unique identification information for each disc, is recorded. The disc 400 further includes an IC chip 430 on which a media ID (PMSN) 431, which is the same as the media ID 421 recorded on the BCA area 420, is recorded.

In the fourth embodiment, the IC chip 430 further has the following data items and functions recorded thereon:

(a) a script 432, which is a simple program for causing execution of a reproducing or copying process complying with the AACS specification;

(b) a URL 433 of, for example, a server to be connected to obtain permission to copy prior to copying content recorded on a disc;

(c) a content ID 434, which is identification information of encrypted content 413;

(d) authentication data 435; and

(e) an authentication processing unit 436.

The data recording area 410 of the disc 400 has the following data items recorded thereon:

an MKB 411, which is a cryptographic key block in which key information used for decoding the encrypted content 413 is stored;

a volume ID 412 of the disc 400, which is an identifier assigned to each unit of manufacture; and

the encrypted content 413, which is data obtained by encrypting content such as a theatrical motion picture.

The data items described above are recorded on the data recording area 410.

The BCA area 420 of the disc 400 has the media ID (PMSN) 421 recorded thereon, which is unique identification information for each disc.

As described above, a BCA area is an area different from a normal data recording area, and data is recorded on the BCA area by using a physical cutting technique, which is different from a standard data recording method. It is therefore difficult to rewrite data recorded on the BCA area, and the reproduction thereof also involves the use of a special reading process, which is different from that of a standard data reproducing process.

An authentication processing sequence using a disc having the data storage structure shown in FIG. 9 will be described with reference to FIG. 10. For example, in a process of copying content stored on a disc having the data storage structure shown in FIG. 9, namely, in a process of copying content recorded on a disc to another medium such as a hard disk, as described above in the foregoing embodiments, a process of accessing a management server and obtaining copy permission information is performed.

In a case where communication is executed by accessing the management server, it is preferable that a process of verifying the authenticity of a management server 480, an information processing apparatus 470, and a disc 400, that is, an authentication process, be performed and a process be performed when the authenticity of the individual devices is verified.

For instance, at least one of an authentication process between the management server 480 and the IC chip 430, an authentication process between an authentication processing unit 436 of the IC chip 430 and an authentication processing unit 479 of the information processing apparatus 470, and an authentication process between the authentication processing unit 479 of the information processing apparatus 470 and an authentication processing unit 486 of the management server 480 can be performed, and copy permission information can be transmitted on condition of successful establishment of authentication.

The information processing apparatus 470 includes the authentication processing unit 479 and authentication data 478, and is configured to enable authentication using such data. The IC chip 430 also includes the authentication processing unit 436 and authentication data 435, and is configured to enable authentication using such data.

For example, the authentication processing unit 479 of the information processing apparatus 470 can perform processes such as an authentication process with the authentication processing unit 436 configured in the IC chip 430 provided in the disc 400 and a process of accessing data recorded on the IC chip 430 on condition of successful establishment of the authentication process.

An authentication process between the management server 480 and the IC chip 430 can also be performed. In this case, the process is performed through the authentication processing unit 479 of the information processing apparatus 470. An authentication process is executed to verify the authenticity of both devices, and a process of sharing a cryptographic key is performed so that communication data is encrypted using the shared cryptographic key before the encrypted data is transmitted and received. This ensures communication with a high security level and secure data communication with reduced potential for data leakage.

Data necessary for an authentication process is recorded on the IC chip 430, for example, the authentication data 435 including a public key of an AACS management center, and a public key and private key suited to the IC chip 430. The authentication processing unit 436 of the IC chip 430 executes communication with the authentication processing unit 486 of the management server 480 through the information processing apparatus 470 using the authentication data 435 to perform an authentication process. In this case, communication is executed through a reader/writer (R/W) 475 and authentication processing unit 479 of the information processing apparatus 470. In FIG. 10, the processing of steps S401 and S402 indicated by a line corresponds to communication during an authentication process. The management server 480 also stores authentication data 485, and executes an authentication process using the authentication data 485.

After the authentication process has been completed and the authenticity of the management server 480 and the IC chip 430 has been verified, the process of obtaining copy permission information described above in the foregoing embodiments is performed. The encryption of communication data using a cryptographic key shared in the authentication process ensures communication with a high security level and secure data communication with reduced potential of data leakage.

In the fourth embodiment, in addition to the media ID (PMSN) 431, the script 432, the URL 433, and the content ID 434 are recorded on the IC chip 430. With this structure, the reading of data from the data recording area of a disc can be omitted during the process of obtaining copy permission information.

In the foregoing description, a process for performing an authentication between the management server 480 and the IC chip 430 has been described by way of example. Alternatively, an authentication may be executed between the authentication processing unit 436 of the IC chip 430 and the authentication processing unit 479 of the information processing apparatus 470, and a further authentication may be executed between the authentication processing unit 479 of the information processing apparatus 470 and the authentication processing unit 486 of the management server 480. In this case, copy permission information may be transmitted on condition of successful establishment of all the authentications. The information processing apparatus 470 also includes the authentication data 478, and is configured to enable authentication using such data.

### Fifth Embodiment

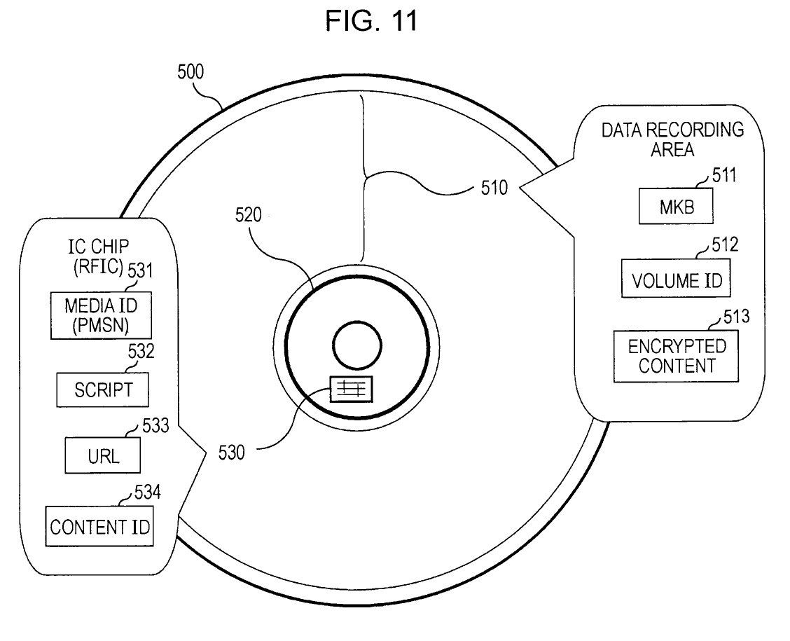

The structure and process of a fifth embodiment of the present invention will be described with reference to FIGS. 11, 12, and 13. FIG. 11 is a diagram showing data recorded on a disc (information recording medium) 500 having content recorded thereon. The disc 500 is a disc, such as a DVD or a Blu-ray Disc® disc, having content such as a theatrical motion picture is recorded on a data recording area thereof.

Unlike any of the discs described above in the first to fourth embodiments, the disc 500 is configured such that a media ID (for example, PMSN), which is unique identification information for each disc, is not recorded on a BCA area 520. Although FIG. 11 shows the BCA area 520, the BCA area 520 may be omitted in the fifth embodiment.

The disc 500 includes a data recording area 510 on which content etc., are recorded, and an IC chip 530 on which a media ID (for example, PMSN) 531, which is unique identification information for each disc, is recorded.

In the fifth embodiment, the IC chip 530 has the following data items recorded thereon:

(a) the media ID (for example, PMSN) 531, which is unique identification information for each; disc

(b) a script 532, which is a simple program for causing execution of a reproducing or copying process complying with the AACS specification;

(c) a URL 533 of, for example, a server to be connected to obtain permission to copy prior to copying content stored on a disc; and

(d) a content ID 534, which is identification information of encrypted content 513.

The data recording area 510 of the disc 500 has the following data items recorded thereon:

an MKB 511, which is a cryptographic key block in which key information used for decoding the encrypted content 513 is stored;

a volume ID 512 of the disc 500, which is an identifier assigned to each unit of manufacture; and

the encrypted content 513, which is data obtained by encrypting content such as a theatrical motion picture.

The data items described above are recorded on the data recording area 510.

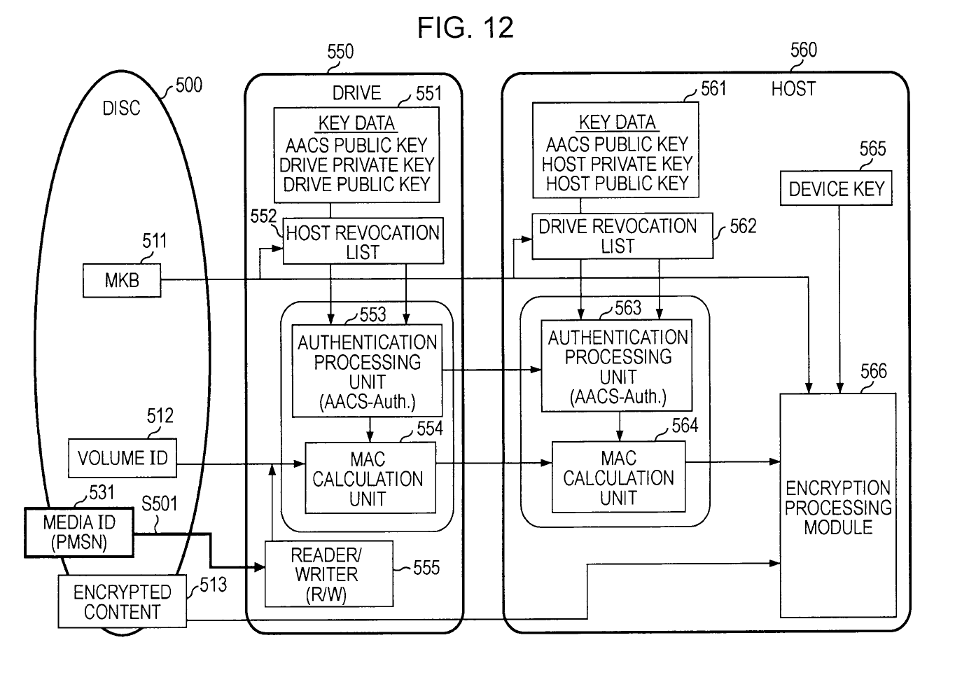

A processing sequence of reproducing content stored on a disc having the data storage structure shown in FIG. 11 will be described with reference to FIG. 12. FIG. 12 shows, from the left to the right, a disc 500 (information recording medium) on which content is stored, a drive 550 that reads data from the disc 500 placed therein, and a host 560 that obtains data recorded on the disc 500 through the drive 550 to decode and reproduce the content. In FIG. 12, the drive 550 and the host 560 are shown separate devices. Alternatively, the drive 550 and the host 560 may be integrated into a single apparatus such as a reproducing apparatus. The disc 500 shown at the left end of FIG. 12 is a disc having the data recording structure described with reference to FIG. 11.

The drive 550 includes key data 551 including a public key of an AACS management center, a drive public key, and a drive private key, and a host revocation list 552. The host revocation list 552 is a list of recorded pieces of identification information of hosts that are determined to be unauthorized hosts by the AACS management center, or a blacklist. As host identification information, for example, identification numbers of host public key certificates corresponding to such hosts are recorded. The host revocation list 552 has been signed using a private key of the AACS management center so as not to be tampered with.

The host 560 includes key data 561 including the public key of the AACS management center, a host public key, and a host private key, and a drive revocation list 562. The drive revocation list 562 is a list of recorded pieces of identification information of drives that are determined to be unauthorized drive devices by the AACS management center, or a blacklist. As drive identification information, for example, identification numbers of drive public key certificates corresponding to such drives are recorded. The drive revocation list 562 has also been signed using a private key of the AACS management center so as not to be tampered with. The host revocation list 552 and the drive revocation list 562 may be recorded on the disc 500, and the drive 550 and the host 560 may read and use the data recorded on the disc 500.

A sequence in a case where the host 560 performs reproduction of content will be described. The host 560 and the drive 550 include an authentication processing unit 563 and an authentication processing unit 553, respectively, and, first, an authentication process is executed between the authentication processing unit 563 of the host 560 and the authentication processing unit 553 of the drive 550. The authentication process is executed according to a processing sequence specified by AACS. In this process, the devices mainly execute the following processes.

The drive 550 reads the host revocation list 552, and verifies the signature of the host revocation list 552 using the public key of the AACS management center to ensure that no tampering has occurred. The drive 550 further confirms that the identification information of the host 560 is not described in the host revocation list 552, or that the host 560 is not revoked.

The host 560 also reads the drive revocation list 562, and verifies the signature of the drive revocation list 562 using the public key of the AACS management center to ensure that no tampering has occurred. The host 560 further confirms that the identification information of the drive 550 is not described in the drive revocation list 562, or that the drive 550 is not revoked.

When it is confirmed that either the drive 550 or the host 560 is not revoked, the drive 550 and the host 560 execute communication of encrypted data according to the AACS specification to generate a shared private key to be shared between the drive 550 and the host 560.

After the completion of the host-drive authentication, the drive 550 reads the volume ID 512 and the media ID (PMSN) 531 from the disc 500. In the fifth embodiment, the media ID (PMSN) 531 is recorded on the IC chip 530 embedded in the disc 500, and the drive 550 reads the media ID (PMSN) 531 from the IC chip 530 of the disc 500 using a reader/writer 555.

In the drive 550, a MAC calculation unit 554 executes, using the data read from the disc 500, a MAC generation process using the shared key generated in the authentication process. The drive 550 transmits a generated MAC value and the media ID (PMSN) 531 to the host 560.

A MAC calculation unit 564 of the host 560 executes a MAC verification process using the shared key. Specifically, the MAC calculation unit 564 performs a MAC generation process using the shared key generated in the authentication process on the media ID 531 received from the drive 550, and matches a generated MAC value with the MAC value received from the drive 550. When the two MAC values match, it is determined that verification has been successfully established. Then, an encryption processing module 566 executes a process of decoding and reproducing content.

In the decoding of content, which is executed by the encryption processing module 566, the MKB 511 is processed using a device key [Kd] 565 to obtain a media key [Km] from the MKB 511, and a process using the media key [Km] is performed to obtain a key for decoding the content. Accordingly, a content decoding process is executed.

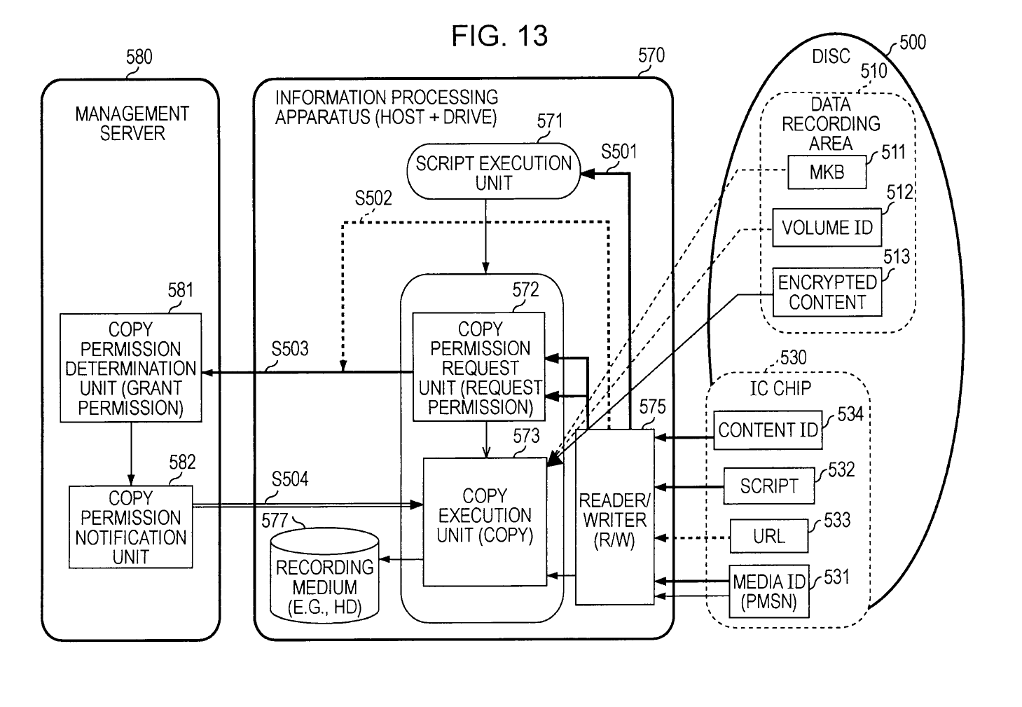

Next, a processing sequence of copying content stored on a disc having the data storage structure shown in FIG. 11 will be described with reference to FIG. 13. Specifically, a processing sequence of copying content recorded on a disc to another medium such as a hard disk will be described.

FIG. 13 shows, from the left to the right, a management server 580 that outputs copy permission information, an information processing apparatus 570 that executes a copying process, and a disc 500 storing content to be copied. The disc 500 is a disc having the data recording structure described with reference to FIG. 11, and has a structure in which a media ID (PMSN) is recorded only on the IC chip 530.

The information processing apparatus 570 is an apparatus having both functions of a host for executing a content reproducing process or copying process and of a drive for driving a disc and reading data.

When the information processing apparatus 570 is to copy the encrypted content 513 recorded on the disc 500 to a recording medium 577 such as a hard disk installed in the information processing apparatus 570, first, the information processing apparatus 570 executes the script (simple program) 532 recorded on the IC chip 530 of the disc 500 using a script execution unit 571 through a reader/writer (R/W) 575 to obtain copy permission information from the management server 580.

In the fifth embodiment, the script 532 is recorded on the IC chip 530, and the information processing apparatus 570 obtains the script 532 from the IC chip 530 through the reader/writer (R/W) 575 and executes the script 532 using the script execution unit 571. In FIG. 13, the processing of step S501 corresponds to a process of reading the script 532.

The script 532 has recorded therein a program for executing a series of procedures for a copying process. A copy permission request unit 572 of the information processing apparatus 570 reads the content ID 534 and media ID (PMSN) 531 recorded on the IC chip 530 of the disc 500 through the reader/writer (R/W) 575. The copy permission request unit 572 further reads the URL 533 recorded on the IC chip 530 through the reader/writer (R/W) 575. In FIG. 13, the processing of step S502 corresponds to a process of reading and accessing the URL 533.

The information processing apparatus 570 transmits the content ID 534 and the media ID (PMSN) 531 to the management server 580 according to the URL 533. In FIG. 13, the processing of step S503 corresponds to a process of transmitting the content ID 534 and the media ID (PMSN) 531.

In this exemplary process, all the script 532, the URL 533, the content ID 534, and the media ID (PMSN) 531 are read from the IC chip 530. Thus, the process of obtaining copy permission information can be performed without performing a reading process from the BCA area 520 or the data recording area 510.

The copy permission request unit 572 of the information processing apparatus 570 transmits the content ID 534 and media ID (PMSN) 531 read from the IC chip 530 in the manner described above to the management server 580 according to the URL 533 read from the IC chip 530.

A copy permission determination unit 581 of the management server 580 receives the content ID 534 and the media ID (PMSN) 531 from the information processing apparatus 570, and checks the content to be copied and the disc 500 on which the content is recorded to determine whether or not copying is permitted. The copy permission determination unit 581 sends copy permission/prohibition determination information to the information processing apparatus 570 through a copy permission notification unit 582 (step S504 of FIG. 13).

When the information processing apparatus 570 receives copy permission information from the management server 580, a copy execution unit 573 reads the encrypted content 513 recorded on the data recording area 510 of the disc 500 and executes a process of copying the read content 513 to the recording medium 577 such as a hard disk installed in the information processing apparatus 570. In this copying process, the encrypted content 513 may be decoded and recorded as decoded content. In this case, the copy execution unit 573 reads information necessary for the decoding process, such as the MKB 511 and volume ID 512 recorded on the data recording area 510 and the media ID (PMSN) 531 recorded on the IC chip 530, and executes a decoding sequence complying with the AACS specification using the read data to obtain the decoded content. The decoded content is recorded on the recording medium 577. The media ID (PMSN) 531 may be implemented using information read during the process of obtaining copy permission information and recorded on a memory in the information processing apparatus 570.

In the content copying process according to the fifth embodiment, therefore, since all the script 532, the URL 533, the content ID 534, and the media ID (PMSN) 531 are read from the IC chip 530, the process of obtaining copy permission information can be performed without performing a reading process from the BCA area 520 or the data recording area 510. This allows rapid obtaining of copy permission information.

In the fifth embodiment, furthermore, the script 532 and the URL 533 are recorded the IC chip 530. The updating of a script defining a server connection processing method or the like or a URL defining a connection destination server can be performed by rewriting data to modify the data. The updating of data can be performed at any time.

In the AACS specification, a media ID (PMSN) should be recorded on a disc. It is currently specified that a media ID be recorded on a BCA area. That is, the structure of the fifth embodiment does not meet the current AACS specification. However, only in a case where a disc in which an IC chip having a media ID (PMSN) recorded thereon is embedded is manufactured and it is necessary to conform the disc to the AACS specification, the media ID (PMSN) recorded on the IC chip may be written to the BCA area later so that an AACS-compliant disc can be provided to a user.

Specific embodiments of the present invention have been described in detail. It is to be understood that a variety of modifications or alterations can be made by persons skilled in the art without departing from the scope of the present invention. That is, exemplary embodiments of the present invention have been disclosed. Those exemplary embodiments are not construed as limiting the present invention. The scope of the present invention should be determined by the appended claims.

The series of processes described herein can be implemented by hardware or software, or a combination thereof. When the series of processes is implemented by software, a program having a processing sequence recorded thereon may be installed into an internal memory of a computer incorporated in dedicated hardware and executed, or may be installed onto a general-purpose computer capable of executing various types of processing and executed. For instance, the program may be recorded in advance on a recording medium and may be installed onto a computer from such a recording medium. Alternatively, the program may be received via a network such as a local area network (LAN) or the Internet and may be installed onto a recording medium such as an internal hard disk.

The processes described herein may be executed in parallel or individually, as well as in the order described herein, according to the performance of the apparatus that performs the processes. The term “system” as used herein refers to a logical set of apparatuses regardless of whether or not the apparatuses are housed in a single housing.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
data reading means for reading a media identifier unique to a disc from an integrated-circuit chip included in the disc;
copy permission request means for transmitting data to a management server, the data including the media identifier read by the data reading means; and
copy execution means for, on condition of receipt of copy permission information from the management server, reading content recorded on the disc and executing a process of copying and recording the content to data recording means different from the disc.

2. The information processing apparatus according to claim 1, wherein the integrated-circuit chip is configured to have recorded thereon
(a) the media identifier configured to uniquely identify the disc, and
(b) a content identifier configured to identify the content recorded on the disc,
wherein the data reading means is configured to read the media identifier and the content identifier from the integrated-circuit chip, and
wherein the copy permission request means is configured to execute a process of transmitting the media identifier and content identifier read from the integrated-circuit chip to the management server.

3. The information processing apparatus according to claim 1, further comprising script execution means for executing a script recorded on the disc, the script being a simple program,
wherein the copy permission request means and the copy execution means perform individual processes according to a program included in the script executed by the script execution means.

4. The information processing apparatus according to claim 3, wherein the integrated-circuit chip is configured to have recorded thereon
(a) the media identifier configured to uniquely identify the disc,
(b) the script that is a simple program, and
(c) a Uniform Resource Locator specifying an address of the management server,
wherein the data reading means is configured to read the script from the integrated-circuit chip,
wherein the script execution means is configured to execute the script read from the integrated-circuit chip, and
wherein the copy permission request means is configured to execute a process of transmitting data to the management server specified by the Uniform Resource Locator, the data including the media identifier read from the integrated-circuit chip.

5. The information processing apparatus according to claim 1, further comprising an authentication processing unit that executes an authentication process,
wherein the authentication processing unit is configured to perform an authentication process with an authentication processing unit provided in the integrated-circuit chip included in the disc, and
wherein the information processing apparatus is configured to execute a process of accessing data recorded on the integrated-circuit chip on condition of establishment of the authentication process.

6. The information processing apparatus according to claim 1, wherein the media identifier is a Pre-recorded Media Serial Number specified by the Advanced Access Content System.

7. A disc having content recorded thereon, comprising:
a data recording portion on which content is recorded; and
an integrated-circuit chip on which a media identifier unique to the disc is recorded,
wherein the integrated-circuit chip is configured so that the media identifier can be read using contactless data reading means, and
wherein when an information processing apparatus is to access the content recorded on the disc, the information processing apparatus is allowed to read the media identifier from the integrated-circuit chip and to execute a data process using the media identifier.

8. The disc according to claim 7, wherein the integrated-circuit chip is configured to have recorded thereon
(a) the media identifier configured to uniquely identify the disc, and
(b) a content identifier configured to identify the content recorded on the disc, and
wherein when the information processing apparatus is to access the content recorded on the disc, the information processing apparatus is allowed to read the media identifier and the content identifier from the integrated-circuit chip and to execute the process using the read media identifier and content identifier.

9. The disc according to claim 7, wherein the integrated-circuit chip is configured to have recorded thereon
(a) the media identifier configured to uniquely identify the disc,
(b) a script that is a simple program, and
(c) a Uniform Resource Locator specifying an address of a management server, and
wherein when the information processing apparatus is to access the content recorded on the disc, the information processing apparatus is allowed to read data from the integrated-circuit chip and to execute the script to perform a process of transmitting the media identifier to the management server specified by the Uniform Resource Locator.

10. The disc according to claim 7, wherein the integrated-circuit chip includes an authentication processing unit that executes an authentication process, and
wherein the authentication processing unit is configured to perform an authentication process with the information processing apparatus that is to access the content recorded on the disc.

11. The disc according to claim 7, wherein the media identifier is a Pre-recorded Media Serial Number specified by the Advanced Access Content System.

12. An information processing method for performing a process of accessing content recorded on a disc using an information processing apparatus, the method comprising the steps of:
reading, using data reading means, a media identifier unique to a disc from an integrated-circuit chip included in the disc;
transmitting, using copy permission request means, data to a management server, the data including the media identifier read by the data reading means; and
executing a copying operation, using copy execution means, on condition of receipt of copy permission information from the management server, by reading content recorded on the disc and executing a process of copying and recording the content to data recording means different from the disc.

13. The information processing method according to claim 12, wherein the integrated-circuit chip is configured to have recorded thereon
(a) the media identifier configured to uniquely identify the disc, and
(b) a content identifier configured to identify the content recorded on the disc, and
wherein the step of transmitting data includes executing a process of transmitting the media identifier and content identifier read from the integrated-circuit chip through the data reading means to the management server.

14. The information processing method according to claim 12, further comprising the step of executing, using script execution means, a script recorded on the disc, the script being a simple program,
wherein the step of transmitting data and the step of executing a copying operation perform individual processes according to a program included in the script executed in the step of executing a script.

15. The information processing method according to claim 14, wherein the integrated-circuit chip is configured to have recorded thereon
(a) the media identifier configured to uniquely identify the disc,
(b) the script that is a simple program, and
(c) a Uniform Resource Locator specifying an address of the management server,
wherein the step of executing a script includes executing the script read from the integrated-circuit chip through the data reading means, and
wherein the step of transmitting data includes executing a process of transmitting data to the management server specified by the Uniform Resource Locator, the data including the media identifier read from the integrated-circuit chip through the data reading means.

16. The information processing method according to claim 12, further comprising the step of performing, using an authentication processing unit, an authentication process with an authentication processing unit provided in the integrated-circuit chip included in the disc,
wherein the information processing apparatus executes a process of accessing data recorded on the integrated-circuit chip on condition of establishment of the authentication process.

17. The information processing method according to claim 12, wherein the media identifier is a Pre-recorded Media Serial Number specified by the Advanced Access Content System.

18. A computer program for causing an information processing apparatus to perform a process of accessing content recorded on a disc, the computer program comprising the steps of:
causing data reading means to read a media identifier unique to a disc from an integrated-circuit chip included in the disc;
causing copy permission request means to transmit data to a management server, the data including the media identifier read by the data reading means; and
causing copy execution means to read, on condition of receipt of copy permission information from the management server, content recorded on the disc and execute a process of copying and recording the content to data recording means different from the disc.

19. An information processing apparatus comprising:
a data reading unit configured to reads a media identifier unique to a disc from an integrated-circuit chip included in the disc;
a copy permission request unit configured to transmit data to a management server, the data including the media identifier read by the data reading unit; and
a copy execution unit configured to, on condition of receipt of copy permission information from the management server, read content recorded on the disc and execute a process of copying and recording the content to a data recording medium different from the disc.
